(19) United States
(12) Patent Application Publication
(10) Pub. No.: US 2007/0154257 A1
(43) Pub. Date: Jul. 5, 2007

(54) Device for connecting structural elements

(75) Inventor: Ove Kornelius Guttormsen, Oslo (NO)

Correspondence Address: RODMAN RODMAN, 7 SOUTH BROADWAY, WHITE PLAINS, NY, 10601, US

(73) Assignee: Ove Kornelius GUTTORMSEN, Oslo (NO)

(21) Appl. No.: 10/597,711

(22) PCT Filed: Feb. 11, 2005
(86) PCT No.: PCT/NO05/00047

§ 371 Date: Sep. 26, 2006

(30) Foreign Application Priority Data
Feb. 13, 2004 (NO) 20040648

(51) Int. Cl. B25G 3/18

(52) U.S. Cl. 403/329

(57) ABSTRACT

A device for connecting structural elements, the device consisting of a male component (301) and a female component (302) having at least over a part of their length wedge-shaped engaging parts (303; 304) having an almost dovetail-like, gradually decreasing cross-section, and wherein the male component and the female component are mountable on a face or edge of the structural elements (307; 308) in order, on movement of the structural elements relative to each other, to cause the male and female components to engage wedgingly. The male and female components each have at least one portion (305′, 305″; 306, 306′) designed for abutment against each other and arranged to prevent the male component from penetrating wedgingly to the maximum into the female component, thereby avoiding reciprocal deformation of the male and female components or material strain thereof on penetration.

The present invention relates to a device for connecting structural elements, as disclosed in the preamble of attached claims 1 and 10, respectively.

Technical solutions for connecting structural elements are already known, where the device consists of a male component and a female component having over at least a part of their length wedge-shaped engaging parts with an almost dovetail-like, gradually decreasing cross-section, and where the male component and the female component are mountable on a face or an edge of the structural elements in order, on movement of the structural elements relative to each other, to cause the male and female components to engage wedgingly.

To further illustrate the state of the art, reference is made to the Applicant's international application, WO 02/052108-A1.

However, it has often been found that the disengagement of such structural elements that are joined in this way frequently involves difficulties because the wedging action causes deformation or material strain of the engaging parts.

Therefore, the object of the present invention is to avoid the said known problems.

According to the invention the device is characterised by the features that are set forth in independent claims 1 and 10.

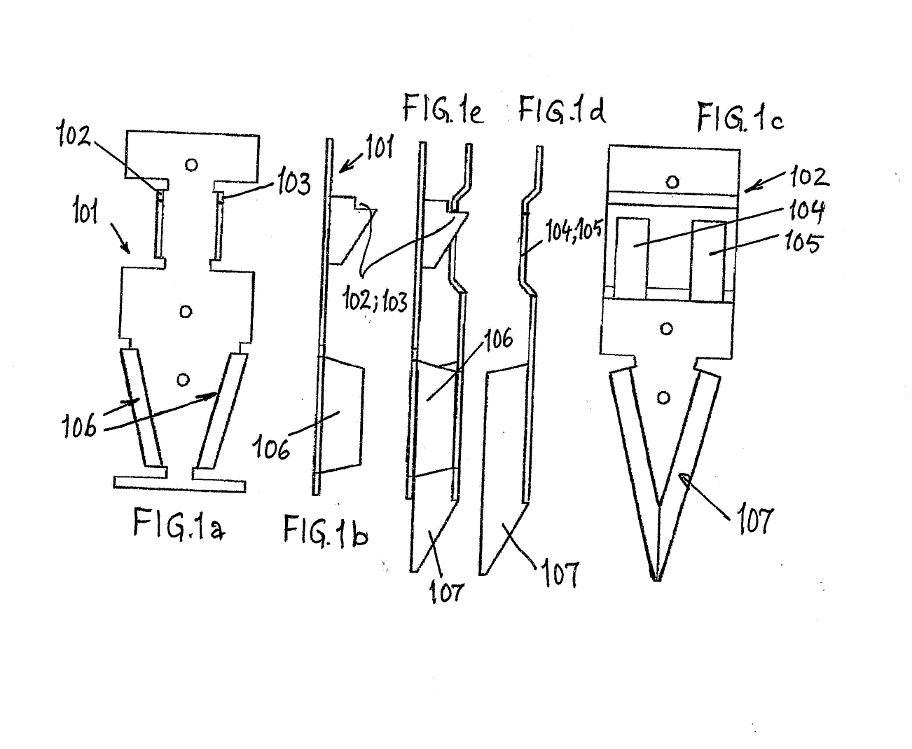

Additional embodiments of the invention are apparent from the attached, respective subsidiary claims 2-9 and 11-13 and the following description with reference to FIGS. 1-9.

The invention will now be described in more detail with reference to the attached drawings.

FIGS. 1a-1e show a first embodiment of the device according to the invention.

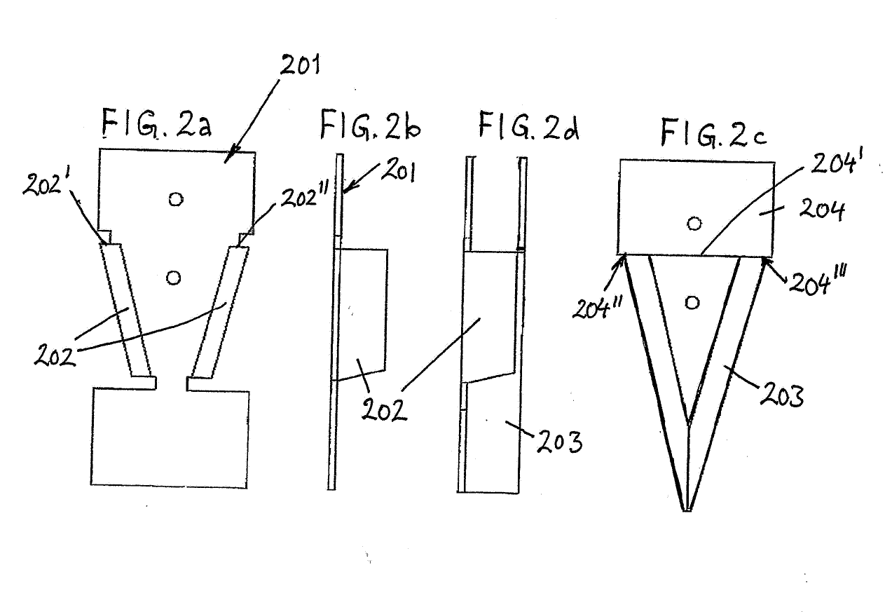

FIGS. 2a-2d show a second embodiment of the device according to the invention.

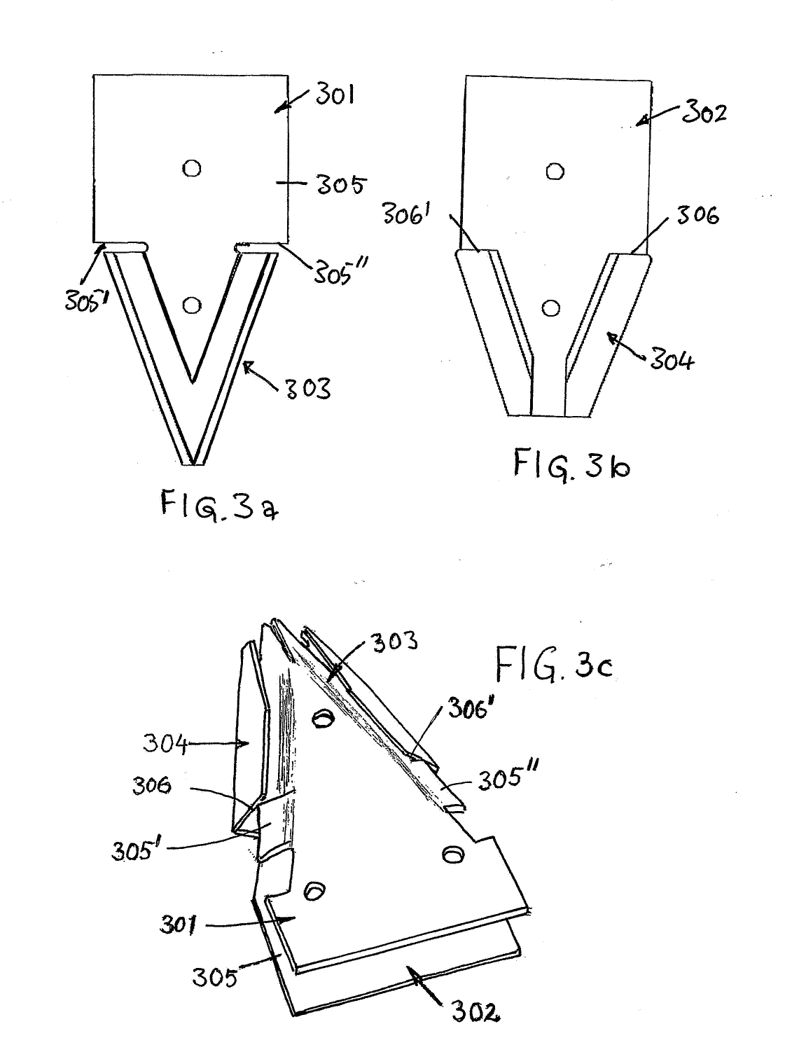

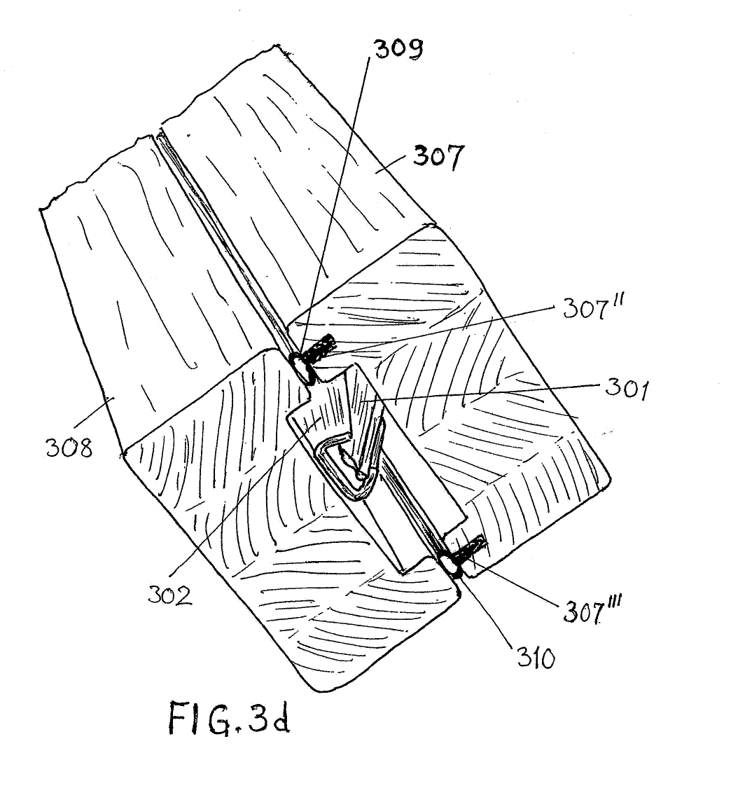

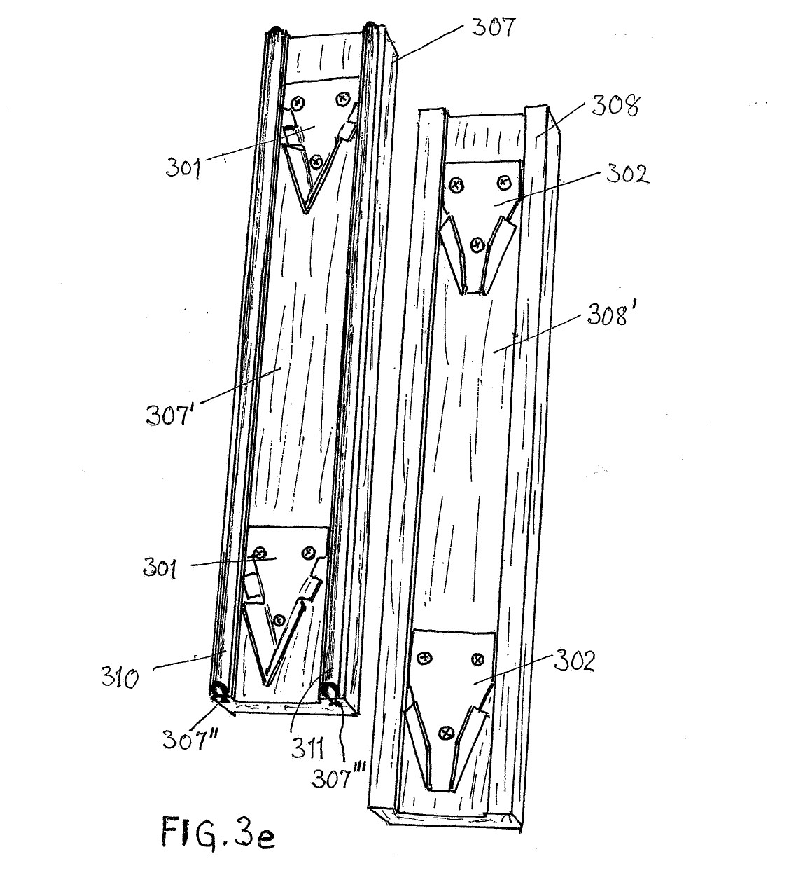

FIGS. 3a-3c show a third embodiment of the device according to the invention, and FIGS. 3d-3e show this embodiment mounted on structural elements.

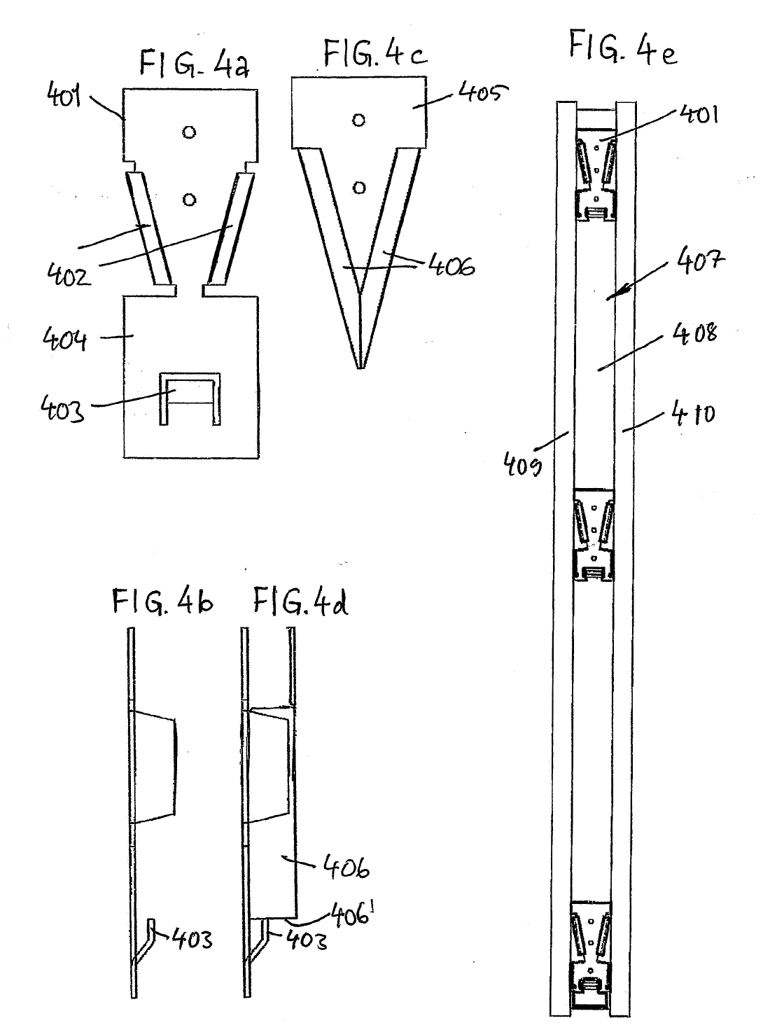

FIGS. 4a-4d show a fourth embodiment of the device according to the invention, and FIG. 4e shows a typical use of this device.

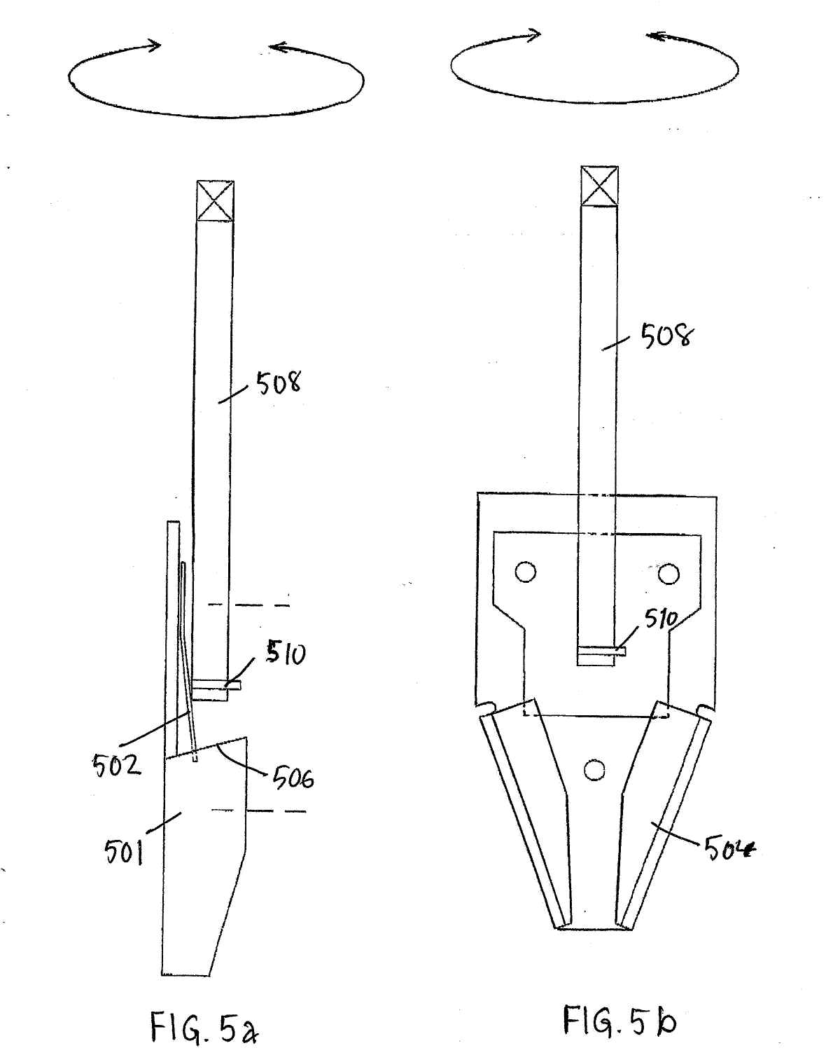

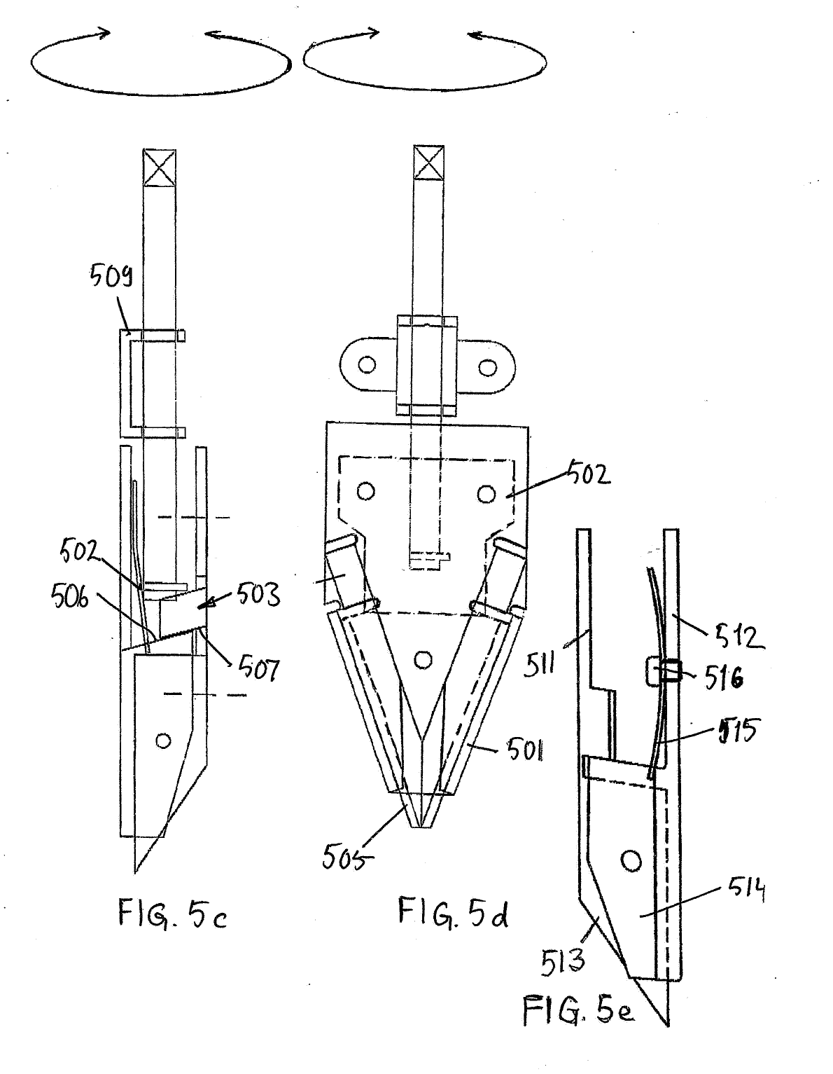

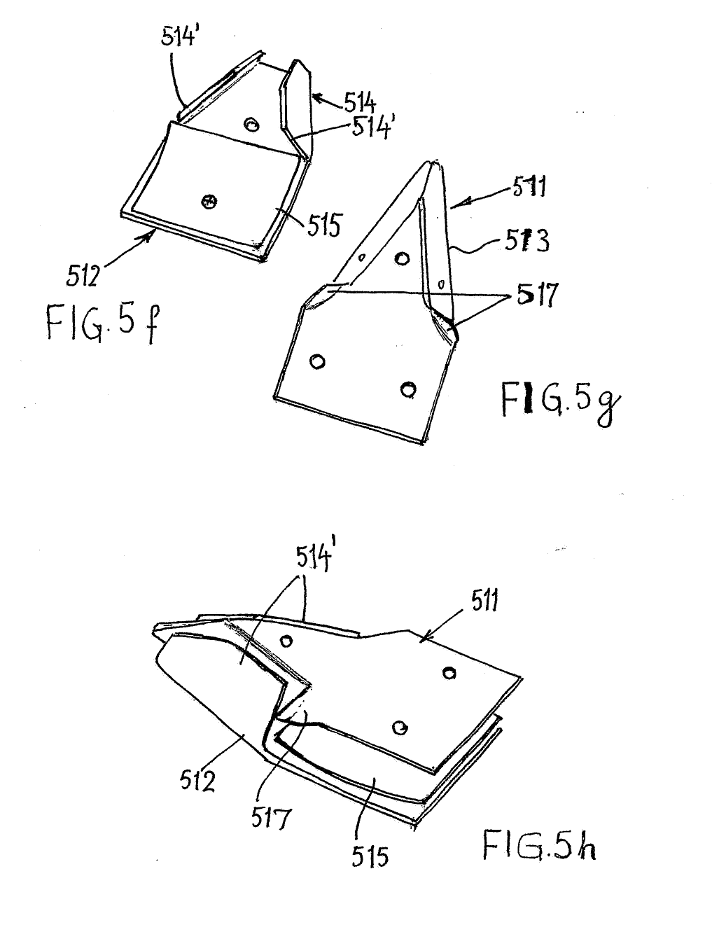

FIGS. 5a-5d show a fifth embodiment of the device according to the invention, and FIGS. 5e-5h show a variant of this embodiment.

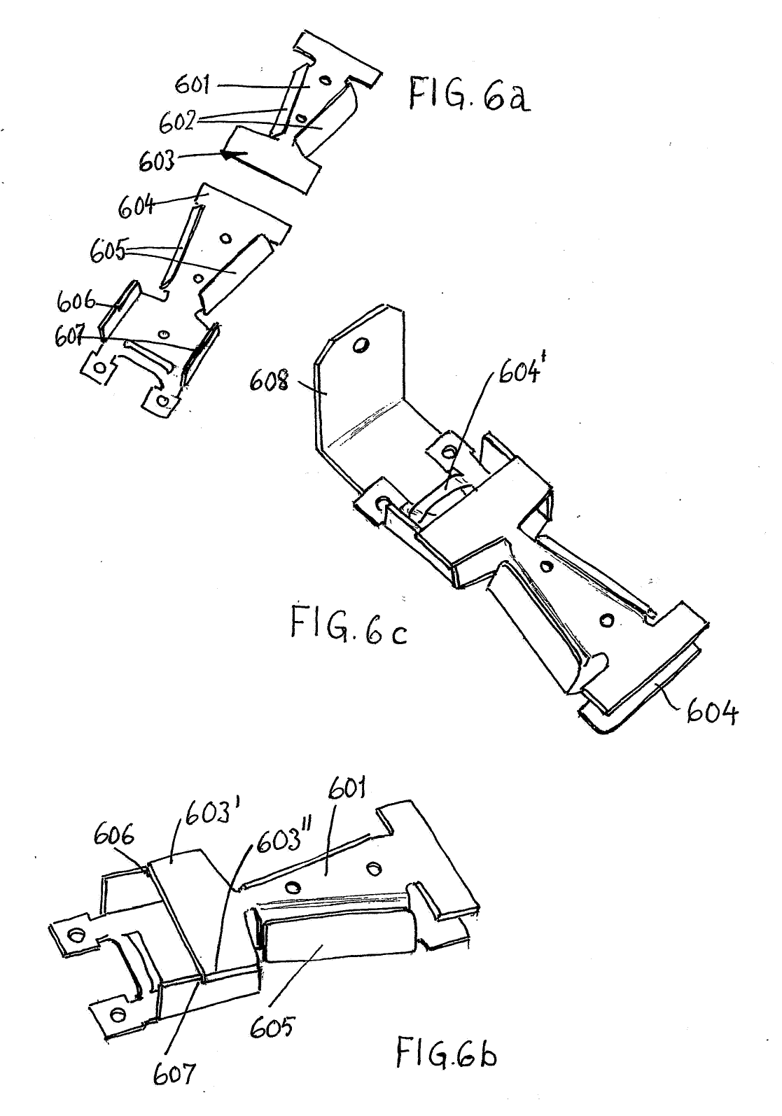

FIGS. 6a-6c show a sixth embodiment of the device according to the invention.

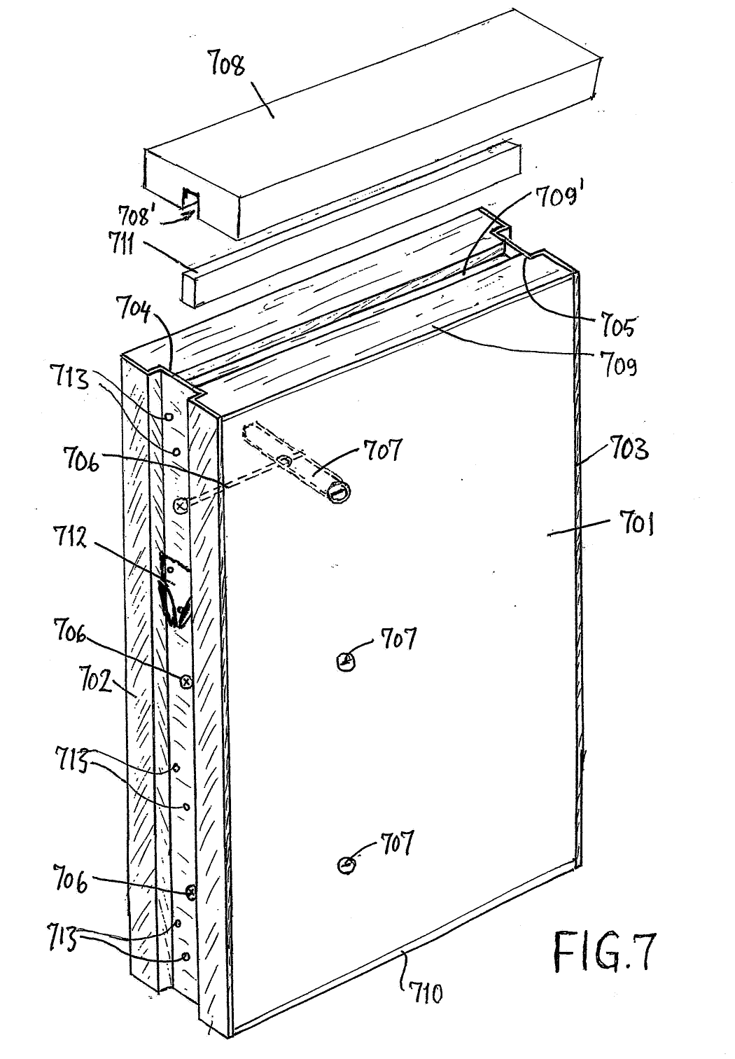

FIG. 7 shows a seventh embodiment of the device according to the invention.

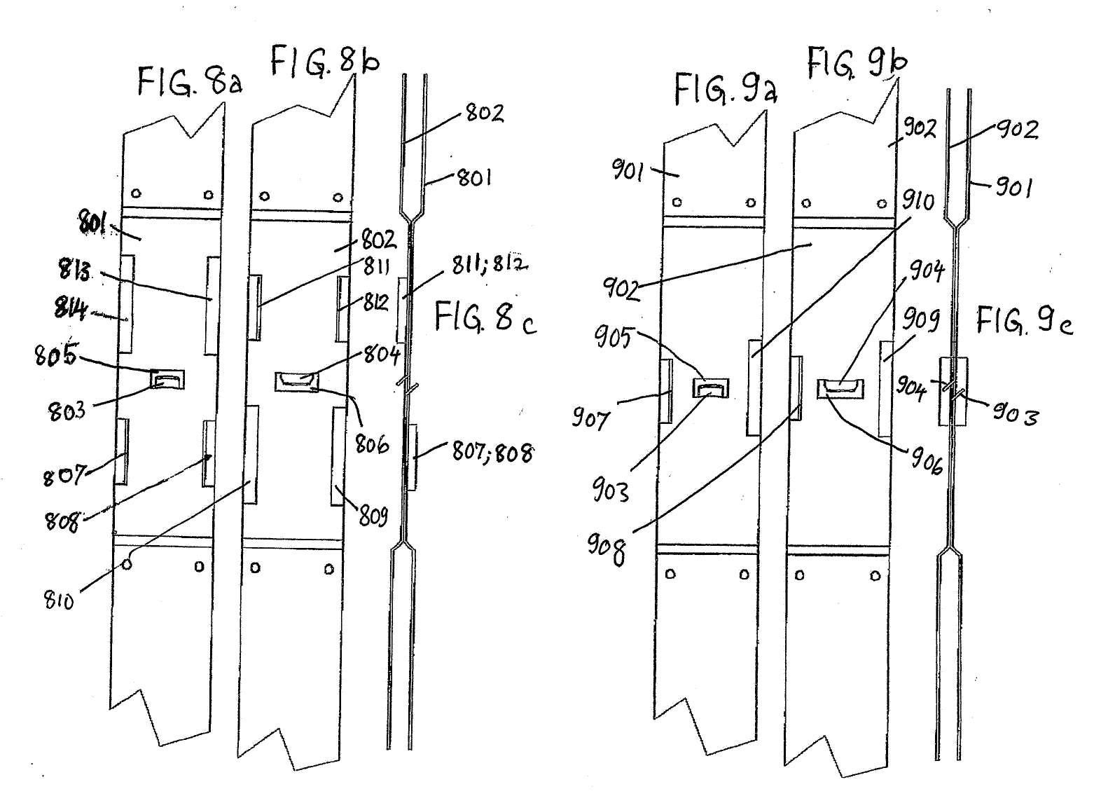

FIGS. 8a-8c show an eighth embodiment of the device according to the invention.

FIGS. 9a-9c show a ninth embodiment of the device according to the invention.

FIGS. 1a and 1b are respectively an elevational view and a side view the female par of the device indicated by the reference numeral 101. The male pat is indicated by the reference numeral 102. On the female part there are two portions 102, 103 which are designed to engage with recesses 104, 105 in the male part. Furthermore, the female part has a wedge portion 106 designed to cooperate with a wedge portion 107 on the male part.

FIG. 1e shows the male part and the female part joined together, with abutting portions 102, 103 in cooperation with the cut-outs 104, 105.

FIG. 2a shows a female part 201, and FIG. 2b is a side view of the female part. The female part has a wedge-shaped engaging portion 202 that is adapted to cooperate with a corresponding wedge-shaped engaging portion 203 on the male part, as is indicated in FIGS. 2c and 2d. The male component is also equipped with a top portion 204, the bottom edge of which at the outer ends 204′, 204″ is designed to rest against an upper edge 202′, 202″ of the wedge 202 on the female part 201.

FIGS. 3a and 3b show a variant of the solution shown in FIG. 2. The male part in this figure is indicated by the reference numeral 301 and the female part by the reference numeral 302. The male part has a wedge-shaped portion 303 for wedging engagement with a wedge portion 304 on the female part. The male part has an upper portion 305, the lower outer edges of which, indicated by the reference numerals 305′, 305″, are designed, on insertion of the wedge 303 into the female wedge 304, to cause the edges 305′, 305″ to abut against the edges 306, 306′. As in the previous solutions, the male component 303 in this case is prevented from penetrating so deeply into the female component 304 that reciprocal deformation of the components or material strain thereof occurs. Such deformation or material strain will inevitably render the disengagement of the two parts difficult. Further details can also be seen from FIG. 3c which shows the male part and the female part joined together. The male part 301 is in other respects similar to the male part 511 in FIGS. 5f-5h. Similarly, the female part 302 is indicated by the reference numeral 512 in FIG. 5.

FIG. 3d is a perspective bottom view of the male part 301 and the female part 302 joined in wedging action for joining together two structural members 307, 308. These structural members 307, 308 are shown here as posts or studs, but it will be understood that the structural members 307, 308 may be incorporated as, for example, studs in a wall element that has side panels and in addition upper and lower cross members in such an element. As is also evident from FIG. 3d and FIG. 3e, it will be seen that the male part(s) 301 is (are) located in a groove 307′ in the structural element 307, and similarly the female part(s) 302 is (are) located in a groove 308′ in the structural element 308. Elastically yielding sealing members or sealing strips 309 and 310 are disposed between the opposing edges of the structural elements, and may, for example, be fixed in a respective slot 307″, 307′″ in one of the structural elements 307. When the male parts and the female parts are brought into the engaged end position, the gap that will exist between the structural members will be sealed by the sealing members. At the same time, the sealing members will cause a tightness between the structural elements

In another solution, as shown in FIG. 4, the female component 401 is equipped with a wedge-shaped part 402, and at the bottom has a projecting stop 403 which extends out from a portion 404 arranged in continuation of the wedge-shaped engaging part 402. Similarly, as shown in FIG. 4c, the male part 405 has a wedge-shaped engaging portion 406 designed to enter over a part of its length into engagement with the wedge-shaped engaging portion 402 on the female part. However, it will be seen from FIG. 4d that the stop 403 is arranged to abut against and support a narrowest end portion 406′ of the wedge-shaped engaging part 406 of the male component.

In FIG. 4e it is shown how, for example, the female part as shown in FIG. 4a can be mounted, for instance on an end edge 407 of a structural element, where 408 denotes the posts of the structural element, and 409, 410 represents, for example, panels on the structural element.

In the solution shown in FIGS. 5a-5d a spring element 502 is mounted on a female component 501 which, on the wedging engagement of the male component 503 with the female component 501, i.e., on engagement of the wedge-shaped portions 504, 505, comes to rest with its edge portion 506 against an edge portion 507 on the wedge-shaped engaging part of the male component 503, there by releasably preventing axial movement of the male and female components in relation to each other. The lower portion of the spring 502 will rest against the male component at the upper portion of its wedge-shaped portion. To release the engagement between the female part 501 and the male part 505, by ending the inhibiting action of the spring 502, there is provided a release bar 508 which with the aid of a holder and guide 509 can be turned so that by means of its release pin 510 the bar 508 pushes the catch 506 back into a position in which it runs clear of an edge engagement with the male part 505. A variant and a practical embodiment of this device can be seen from FIG. 5e, in which the male part is indicated by the reference numeral 511 and the female part is indicated by the reference numeral 512. The male part has a wedge-shaped portion 513 and the female part has a corresponding wedge-shaped portion 514. A spring 515, preferably a curved, flat spring, is fastened to the female part by a screw 516. When the lower portion of the spring 515 is pressed in, the male part and the female pat will have their mutual engagement released, whereupon the two parts can be separated.

A practical embodiment of that shown in FIG. 5e is shown in more detail in FIGS. 5f-h.

FIG. 5f shows a female part 512 with its wedge-shaped portion 514 and further provided with a spring 515. FIG. 5g shows a male part 511 with a wedge-shaped engaging portion 513. FIG. 5h shows the male component 511 and the female component 512. It will be seen that lugs 517 come to rest against an upper portion 514′ of the wedge-shaped part 514 of the female component.

The spring 515 is preferably a leaf spring, and the release counterforce of the spring may be adjustable by the degree of tightening of the fixing screw 516.

Another embodiment of the device is shown in FIGS. 6a-6c. This embodiment is similar to the embodiment shown in FIG. 1 and in FIG. 4. The figure shows a male part 601 with wedge part 602 and a lug portion 603 designed to limit the movement of the male component 601 and the female component 604 in relation to each other in the axial direction when wedging engagement is to take place. The female part 604 has a wedge portion 605 and, at the bottom, the female component 604 has a portion arranged in continuation of its wedge-shaped engaging part 605 to abut against and support the lug portion 603 and its two lug parts 603′, 603″. The abutting portions on the female part are indicated respectively by the reference numerals 606 and 607. In this way, wedging cooperation is obtained between the male part 601 and 604, although without deformation or material strain of the male and/or female component occurring. In FIG. 6c it is shown how an end portion 604′ of the female part 604 can be equipped with an angle piece 608 that engages with the end portion 604′. The angle piece 608 may be useful in special cases of assembly.

In FIG. 7 it is shown how the invention can be used, for example, in the case where the male and female parts cannot be screwed into wooden studding in building elements, but where, for example, the whole building element 701 is basically made of lightweight concrete (for example, so called “ytong”) “aerated concrete”, “clinker” concrete, so-called “Leca” elements, or a polymer material having at least a hard, UV-resistant surface, as opposed to the upper and lower cross members, panels on each side and optional insulation inside the building element cavity of an ordinary building element without studding. However, a satisfactory fixing for screws in lightweight concrete is difficult to obtain and gives poor fixing in the longitudinal direction of the screw. In FIG. 7 it is shown that along each vertical edge of the element 701 there is fastened a fitting 702, 703, for example, of profiled aluminium which runs in a slot 704, 705 in an end edge of the element. To affix such a fitting, a plurality of fixing screws 706 could be used, for example, which form threaded engagement with a fixing bolt 707 acting as a nut and extending transverse to the element 701. A fixing screw/fixing bolt solution of this kind is known from, inter alia, furniture constructions. As an alternative, it is possible to use an expanding bolt, but this does not give a simpler and cheaper solution and is less favourable as regards fitting. To ensure lateral anchoring of the element 701 at a top sill 708 and a bottom sill (not shown), the top and bottom of the element are preferably equipped with a profiled fitting 709, 710, for example, of aluminium, which lies in a slot (not shown) in the top and bottom of the element. The fitting, such as the fitting 709 in this case, has a countersink 709′ designed partly to accommodate a coupling strip 711 which is to form engagement with a groove 708′ in the top sill. The same will apply to a sole sill, although this is not shown here. The principle is described in more detail in the aforementioned WO document. Although the top sill and bottom sill, and coupling piece, may, for example, be made of wood, it is of course possible to envisage these elements made of, for example, extruded aluminium. It will be seen that the fitting 709, 710, together with the fittings 702 and 703, obtains good sideways anchoring on the element 701, and since they also engage with each other, a frame is virtually obtained around the element 701. Since the fittings 709, 710 are laterally in engagement with the fittings 702 and 703, and there is no vertical pull on the fittings 709, 710, these can simply be glued to the element 701 and/or to upper and lower ends of the fittings 702, 703. FIG. 7 also indicates a coupling element, here in the form of a female part 712, as for instance the female part 302, which is capable of being screwed securely into the vertical fitting, in this case the fitting 702. The reference numeral 713 indicates screw holes for additional coupling elements (not shown).

The solution shown in FIG. 7 will be particularly suitable in areas of the world where access to timber is limited or timber is expensive, or where climatic or environmental conditions, for example, large humidity swings, wood-eating insects or the like, dictate that the use of wood should be avoided to ensure form stability and the lifetime of the structure.

FIGS. 8a and 8b show two connecting rails 801; 802 which have respectively both a male component 803; 804 and a female component 805; 806. Components 807, 808 engage in respective grooves 809, 810 on the opposing rail 802. Similarly, components 811, 812 on the rail 802 will engage with grooves or cut-outs 813, 814 in the rail 801. The components 807, 808, 811, 812 ensure lateral stabilisation and at the same time prevent the engagement between the male and female components causing material strain thereof, in that movement of the components 807, 808, 811, 812 in the vertical direction downwards in respective grooves 809, 810, 813, 814 is limited by the lower edge of these grooves.

FIGS. 9a and 9b show a similar solution where there are two rails 901, 902 which in a similar manner are designed for fitting on an end edge of a structural element, for example, a building element (not shown). Each rail 901, 902 has respectively both a male component 903; 904 and a female component 905; 906. Components 907, 908 on respectively the rails 901 and 902 engage with respective grooves 909, 910 on opposing rail 902; 901, thereby ensuring lateral stabilisation and restriction of movement in the vertical direction, as shown and described for FIG. 8

Current status of claims:

1. A device for connecting structural elements, the device consisting of a male component and a female component having at least over a part of their length wedge-shaped engaging parts having an almost dovetail-like, gradually decreasing cross-section, and wherein the male component and the female component are mountable on a face or edge of the structural elements in order, on movement of the structural elements relative to each other, to cause the male and female components to engage wedgingly, characterised in that the male and female components each have at least one portion designed for abutment against each other and arranged to prevent the male component from penetrating wedgingly to the maximum into the female component, thereby avoiding mutual deformation of the male and female components or material strain thereof on penetration. (FIGS. 1-7)

2. A device as disclosed in claim 1, characterised in that the male component is equipped with two lugs that are arranged to abut against and be supported by respective edge portions on the wedge-shaped engaging part of the female component. (FIGS. 2, 3)

3. A device as disclosed in claim 1, characterised in that the female component is equipped with two lugs that extend out to the side from a portion arranged in continuation of the wedge-shaped engaging part, and that the female component similarly has a portion arranged in continuation of its wedge-shaped engaging part in order to abut against and support said lugs. (FIG. 6)

4. A device as disclosed in claim 1, characterised in that the female component is equipped with a projecting stop that extends out from a portion arranged in continuation of the wedge-shaped engaging part, the stop being arranged to abut against and support a narrowest end portion of the wedge-shaped engaging part of the male component. (FIG. 4)

5. A device as disclosed in claim 1, characterised in that the female component has projections designed to engage with a corresponding recess in the male component in order, on insertion of the male component into the female component, to limit the insertion in that a short end of the recess comes to rest against the projection. (FIG. 1)

6. A device as disclosed in claim 1, characterised in that on the female component there is arranged a inhibiting device which, on the wedging engagement of the male component with the female component, enters releasable engaging abutment with an edge portion of the inhibiting device against an edge portion of the wedge-shaped engaging part of the male component, the inhibiting device thus releasably inhibitinh against axial movement of the male and female components. (FIG. 5)

7. A device as disclosed in claim 6, characterised in that the inhibiting device is a retaining spring whose engagement with the male component is releasable by means of a release bar which can be passed into a space defined by the male and female components in order, on the turning of the bar about its longitudinal axis, to provide by means of a pin or eccentric disc affixed to the bar, a bending of the spring so as to release the engagement with the male component. (FIG. 5)

8. A device as disclosed in claim 6, characterised in that the retaining spring is a leaf spring, and that the releasing counterforce of the spring is adjustable, for example, by means of at least one combined adjusting and fixing screw. (FIG. 5)

9. A device as disclosed in claim 1, characterised in that an angle piece is attachable to at least one end portion of the female part. (FIG. 6c)

10. A device for connecting structural elements, wherein the device consists of at least two male components and two female components which are mountable on a face or edge of the structural elements in order, on movement of the structural elements relative to each other, to cause the male and female elements to engage, characterised in that the male component is in the form of an angled hook designed to be passed with wedging action into the female component, and that the device consists of two connectable rails, that each rail has at least one pair of male and female components arranged as an integral unit, wherein a recess that is adjacent to a male component in a rail forms a female component in this rail and is designed for engagement with a male component in the opposing rail, that on mutual engagement between the rails the opposing male components have opposing faces resting against each other, and that the rails are equipped with engaging members for limiting the vertical movement of the rails in relation to each other, and thus the movement of the male and female components in relation to each other and their degree of engagement. (FIGS. 8 and 9).

11. A device as disclosed in claim 10, characterised in that the engaging members of the rails in addition are designed for lateral stabilisation of the rails.

12. A device as disclosed in claim 1, characterised in that the structural elements are formed of a non-compostable material, for example, lightweight concrete, and that a profiled attachment fitting for securing said male parts and female parts is secured to at least one end portion of the structural member.

13. A device as disclosed in claim 12, characterised in that sealing strips are disposed between two adjacent structural members.

14. A device as disclosed in one or more of claim 10, characterised in that the structural elements are formed of a non-compostable material, for example, lightweight concrete, and that a profiled attachment fitting for securing said male parts and female parts is secured to at least one end portion of the structural member.
